(19) United States
(12) Patent Application Publication
(10) Pub. No.: US 2026/0267123 A1
(43) Pub. Date: Sep. 10, 2026

(54) ILLUMINATION DEVICE FOR A LIGHT-SHEET MICROSCOPE

(71) Applicant: Carl Zeiss Microscopy GmbH, Jena (DE)

(72) Inventors: Joerg SIEBENMORGEN, Jena (DE); Richard HOLLINGER, Jena (DE); Ralf NETZ, Jena (DE)

(21) Appl. No.: 19/560,711

(22) Filed: Mar. 9, 2026

(30) Foreign Application Priority Data
Mar. 10, 2025 (DE) 10 2025 108 955.8

(51) Int. Cl. G02B 21/08

(52) U.S. Cl. CPC G02B 21/08

(57) ABSTRACT

An illumination device for a light-sheet microscope, including a light source that emits coherent light, light-shaping means, which shape the light into a light beam, an illumination optics unit, which guides the light beam into a specimen and illuminates the latter, and an amplitude mask arranged between the light-shaping means and the illumination optics unit and that imposes an intensity distribution on the light beam. In a first alternative for generating a static light sheet, the light-shaping means comprise a first beam-shaping optics unit, which generates a light beam with a linear cross section perpendicular to a direction of propagation, and the amplitude mask a first slit mask. In a second alternative, the light-shaping means comprise a second beam-shaping optics unit, which forms a light beam with a round cross section perpendicular to the direction of propagation. The amplitude mask is the first slit mask or a first annular mask.

### CROSS-REFERENCE TO RELATED APPLICATIONS

This application claims the benefit of German Patent Application No. 10 2025 108 955.8, filed Mar. 10, 2025, the entire disclosures of which are incorporated herein by reference.

### FIELD OF THE INVENTION

The invention relates to an illumination device for a light-sheet microscope. Such an illumination device comprises a light source that emits coherent light, for example one or more lasers. The illumination device moreover comprises light-shaping means, which shape the light emitted by the light source into a light beam with a direction of propagation, and an illumination optics unit, which is arranged downstream of the light-shaping means in the direction of propagation of the light beam and images the light beam into a specimen and illuminates the latter, wherein the illumination optics unit has a light entrance side, which faces the light-shaping means and at which the light beam enters the illumination optics unit, and a light exit side, from which the light beam for illuminating a specimen exits, and comprises at least one converging lens, which is rotationally symmetrical about an optical axis and is arranged on the light entrance side of the illumination optics unit—which thus faces the light-shaping means. The illumination optics unit may also be formed exclusively by the converging lens.

### BACKGROUND OF THE INVENTION

The examination of biological specimens in which the specimen is illuminated with a light sheet, the plane of which—the light sheet plane—intersects the optical detection axis—the detection direction—at a non-zero angle, has become increasingly important in recent times. The light sheet plane typically encloses with the detection direction, which generally corresponds to the optical axis of the detection objective, a non-zero angle, which is frequently—but not necessarily—a right angle. Such examination methods are primarily used in fluorescence microscopy and are combined under the term LSFM (light sheet fluorescence microscopy). One example is the method designated as SPIM (selective plane illumination microscopy), which is described in DE 102 57 423 A1 and, building thereon, in WO 2004/0535558 A1 and with which spatial recordings even of relatively thick specimens can be created within a relatively short period of time: A visual/spatially extended representation of the specimen is possible on the basis of optical sections combined with a relative movement in a direction perpendicular to the section plane.

The LSFM methods have a number of advantages over other established methods such as confocal laser scanning microscopy or two-photon microscopy. Since the detection can be undertaken in the wide field, it is possible to capture relatively large specimen regions. Even though the resolution is somewhat lower than in confocal laser scanning microscopy, it is possible to analyze thicker specimens using the LSFM technique because the penetration depth is greater. Moreover, this method involves the lowest light dose to the specimen, reducing the risk of bleaching of a specimen since the specimen is illuminated only by a thin light sheet at a non-zero angle with respect to the detection direction.

Rather than a purely static light sheet, it is also possible to generate a quasi-static light sheet by quickly scanning the specimen with a light beam. The light sheet-type illumination is produced by moving the light beam very quickly relative to the specimen under observation and repeating this multiple times in temporal succession to create a series. The integration time of the camera onto the sensor of which the specimen is imaged is selected such that the scanning is concluded within the integration time. Here, “quickly” means that the integration time of the spatially resolving area detector generally used, for example a camera with a CCD chip or CMOS chip, is selected such that the light beam scans the region of the specimen corresponding to the quasi-static light sheet within this integration time. The integration time—which, in the case of the camera, corresponds for example to the opening time of the shutter—and the scanning frequency or scanning time of the light beam can generally also be set independently of one another, thus allowing the scanning time to be adapted to a fixed integration time. Since scanning using a rotationally symmetrical light beam in effect also generates a light sheet, at least in terms of its effect, this approach is also subsumed under the generation of a light sheet.

One of the main applications of light-sheet microscopy lies in imaging medium-sized organisms of several 100 μm up to a few millimeters. Said organisms are generally embedded in a gel, for example agarose, which is in turn situated in a glass capillary. The glass capillary is introduced into a water-filled specimen chamber from above or from below and the specimen is forced out of the capillary a little way. The specimen in agarose is illuminated with a light sheet and the fluorescence is imaged onto a camera using a detection objective, which is—preferably but not necessarily—perpendicular to the light sheet and thus also perpendicular to the illumination objective of an optical system for generating a light sheet.

This method of light-sheet microscopy, however, is subject to certain limitations. Firstly, the specimens to be examined are relatively large; they originate from developmental biology. Secondly, on account of the specimen preparation and the dimensions of the specimen chamber, the light sheet is relatively thick and the axial resolution that can be achieved is thus limited. Thirdly, the preparation of the specimens is complex and incompatible with standard specimen preparations and standard specimen mounts as are customary in fluorescence microscopy for individual cells.

Generally, coherent laser light is used to illuminate the specimen. In fluorescence microscopy, the wavelength of the light is selected depending on markers that are intended to be excited in order to emit fluorescence. In the simplest case, for example a light beam having an intensity profile that corresponds to a Gaussian function can be shaped into a light sheet statically by means of cylindrical lenses or quasi-statically by means of scanning and a camera integration time that is matched thereto. The advantage here is structured illumination of the specimen, as a result of which the resolution can be increased. For example, the coherent superposition of Bessel beams is described in an article by V. Kettunen et al., “Propagation-invariant spot arrays”, published in Optics Letters 23(16), page 1247, 1998. The superposition is achieved by using an algorithm to calculate a phase element that can be introduced into the pupil of a binary diffraction element. If the spectrum of a Bessel beam is imaged into the pupil, the phase element generates a multiplicity of Bessel beams which are superposed in the specimen. The phase element is similar to a star-shaped grating having the phase values 0 and π. It is specified as a condition that the spacing between the individual Bessel beams must be large, since otherwise undesired interference effects can occur.

In US 2013/0286181 A1, the interference effects between the individual Bessel beams are used in a targeted manner in order to generate an extended and structured light sheet. In this case, the Bessel beams are arranged next to one another so closely that the secondary maxima of the individual Bessel beams above and below the propagation plane, the light sheet plane, are destructively superposed. Depending on the spacing between the individual Bessel beams, different interference patterns are formed.

WO 2014/005682 A2 describes the generation of what are known as sinc³ beams. This makes it possible to generate a nearly cuboid light sheet with only small secondary maxima in the specimen.

For example, SLMs (spatial light modulators) may be used to generate the beam types described above. The light sheets generated in this way are not only partially structured, but also have, compared to simple light sheets generated from a Gaussian beam—this being understood to mean a light beam that has a rotationally symmetrical intensity profile with an intensity distribution corresponding to a Gaussian function—only using a cylindrical lens, the advantage of having, over a longer range, a narrow beam waist—also known as the light sheet length—over a larger region of the specimen. An illumination device in which a light sheet is generated by means of sinc³ light beams is described by way of example in DE 10 2012 013 163 A1.

Although generating, for example, sinc³ light sheets using spatial light modulators offers maximum flexibility, it is not without its disadvantages. For instance, such an illumination device is much more expensive to implement than simple light sheet generation from Gaussian beams by means of cylindrical lenses and moreover requires a lot of installation space.

Solutions that also allow light sheets with a longer beam waist to be generated using cylindrical lenses have already been described in the prior art. For instance, DE 10 2007 063 274 B4 describes an illumination device for generating a light sheet in which use is made of a Bessel optics unit in which a stop, which is configured as a double-slit mask and is arranged in a (conjugate) pupil plane, is arranged between the light source and cylindrical lens. The double slit is used to generate two plane waves from the light beam with a Gaussian intensity profile, which are focused using a cylindrical lens. A light sheet with an increased light-sheet length compared to cylindrical-lens illumination without a double-slit mask is generated at the focus of the cylindrical lens. This can also reduce shadowing, but not as much as would be possible with an angle scan—illuminating a specimen with the light sheet from different directions in a narrow angular range. However, such an angle scan is difficult to implement in the illumination device described in DE 10 2007 063 274 B4. Moreover, the illumination device does not offer any flexibility in terms of selecting light sheets of different lengths and/or thicknesses.

The article “Towards the optical ‘magic carpet’: reducing the divergence of a light sheet below the diffraction limit” by I. Golub et al., published in Optics Letters, Vol. 40, No. 21, Nov. 1, 2015, pages 5121-5124, describes how a mask having two or four slits can be used to generate a light sheet with a greater length. The mask is applied directly to the rear side of the cylindrical lens, which is facing the light source, and specifically adapted to the specimen-side focal length of the cylindrical lens.

EP 3 500 885 B1 describes an illumination device for a light-sheet microscope that provides illumination as described in the above-mentioned article by I. Golub. FIG. 3 of EP 3 500 885 B1 shows a cylindrical lens 104, with which a photomask 102 is in contact on the light source side; the slits of the photomask 102 are placed sufficiently close to the optical axis, as may be gathered from FIG. 4, that the photomask can actually be considered to be mounted on the cylindrical lens. In addition, the photomask is in contact with the cylindrical lens. In addition, the assembly of the light source, photomask and cylindrical lens is tilted by a small angle, so that the optical axis of the illumination device makes a non-90° angle with the optical axis of a detection objective. In this assembly, it is almost impossible to change between different masks unless the cylindrical lens is also changed at the same time, since otherwise an extremely precise adjustment would have to be made.

### SUMMARY OF THE INVENTION

The object of the invention is therefore to provide an illumination device that makes it possible to provide a light sheet with a longer beam waist—compared to a light sheet generated from a light beam with a Gaussian intensity profile by means of a cylindrical lens—wherein the design of the illumination device should be as compact and cost-effect as possible. Moreover, the illumination device should make it possible to adapt the thickness of the light sheet and the length of the light sheet in a straightforward manner. Furthermore, there should be the option of illuminating the specimen not only using a static light sheet but also optionally using a quasi-static light sheet, i.e. a light beam that is scanned over the specimen.

This object is achieved for an illumination device of the kind described at the outset by virtue of the light-shaping means comprising, in a first alternative, a first beam-shaping optics unit, which forms a light beam with an approximately linear cross section perpendicular to the direction of propagation, i.e. the precursor of a static light sheet, which is then guided, in the form of a light sheet, into a specimen by the illumination optics unit arranged downstream of the light-shaping means in the direction of propagation of the light beam. “Approximately linear” means that the laser beam has a significantly larger extent in a first direction than in a second direction perpendicular thereto. For example, the cross section may be rectangular; in this case—unlike in the prior art, where the finished light sheet has already been shaped by means of the cylindrical lens—it is merely the precursor of a light sheet and can be generated using one or more cylindrical lenses. The intensity profile of the light beam may correspond to a Gaussian function, a top-hat or flat-top distribution or another intensity distribution. The illumination device also comprises an amplitude mask, which is arranged in a back focal plane or in a pupil plane of the converging lens of the illumination optics unit conjugate to said back focal plane, wherein the illumination optics unit can be in the form of a microscope objective, for example. The light beam emanating from the light-shaping means thus illuminates the amplitude mask first, before it enters the illumination optics unit on its light entrance side. This amplitude mask imposes an intensity distribution on the light beam. In the first alternative of the light-shaping means, the amplitude mask is in the form of a first slit mask, which comprises at least two slits that are arranged parallel to one another and mirror symmetrically in relation to the optical axis and have slit lengths and slit widths that are shorter than the slit lengths, wherein the slit lengths are oriented perpendicular to a line formed by the linear cross section. Depending on the application, masks with more than two slits may also be used; for example, the slit mask may also have four or six slits. The mirror symmetry in relation to the optical axis is retained in this case. In this first alternative of the light-shaping means, an amplitude modulation is thus imposed on the precursor of the light sheet, the light beam with a linear cross section, before the light beam is finally shaped into a light sheet by the illumination optics unit and imaged onto the specimen/introduced into the specimen. The illumination optics unit contains at least one converging lens, but no other cylindrical lenses any more. The amplitude mask can thus be decoupled and positioned away from a cylindrical lens and the converging lens, facilitating an exchange. In addition to the amplitude mask being positioned in the back focal plane of the converging lens of the illumination optics unit, the amplitude mask can also be positioned in a pupil plane conjugate to said back focal plane, thus increasing flexibility, if it is possible, for example, for different amplitude masks to be interchangeably introduced into the beam path at different positions. In principle, it is also conceivable for the amplitude mask to be positioned close to the pupil.

While in the first alternative of the light-shaping means a static light sheet is generated, in a second alternative of the light-shaping means, the illumination device is designed to generate a quasi-static light sheet. The light-shaping means therefore comprise, in the second alternative, a second beam-shaping optics unit, which forms a light beam with a round cross section perpendicular to the direction of propagation of the light. In the second alternative of the light-shaping means, the amplitude mask is either in the form of the first slit mask or in the form of a first annular mask with at least one annular opening. The intensity profile of the light beam may correspond to a Gaussian function, a top-hat or flat-top distribution or another intensity distribution. If the first slit mask is used, the light beam is modulated sinusoidally in a direction perpendicular to the slit lengths. In order to be able to scan this light beam for generating the light sheet, a first scanning mirror, which is used to shape the light beam into a dynamic light sheet, is arranged in a pupil plane conjugate to the back focal plane of the illumination optics unit. In principle, the order in which the first scanning mirror and the amplitude mask are arranged in the beam path does not matter. The scanned light beam can then be used for detection purposes, for example in conjunction with a rolling shutter of a camera, in order to achieve confocal filtering of the light to be detected, generally fluorescence emanating from the specimen.

The illumination device may be configured such that it contains just one of the two alternative beam-shaping optics units or both. If it contains both beam-shaping optics units, the illumination device expediently has a switch or switching means for selecting one of the two beam-shaping optics units and optionally also the amplitude mask. The switching means may be configured to be driven mechanically or by a motor and for example can pivot either one or the other beam-shaping optics unit into the beam path in the manner of a slide.

However, in the case of a light-sheet microscope comprising the illumination device according to the invention, it may also be advantageous for the two alternative beam-shaping optics units to be configured as mutually interchangeable modules that can be exchanged as necessary, thus making it possible to minimize the space used.

In one particularly preferred configuration of the illumination device, in particular if it comprises a first beam-shaping optics unit according to the first alternative of the light-shaping means, a second scanning mirror is arranged in an intermediate image plane conjugate to an object plane of the illumination optics unit. This second scanning mirror makes it possible to displace the position of the light beam on the first slit mask, i.e. the amplitude mask, along the slit lengths. The second scanning mirror can be configured, for example, as a galvanometric mirror or as a MEMS mirror, i.e. as a mirror based on a micro-electromechanical system (MEMS). Pivoting the mirror produces a scanning motion, which displaces the light beam with an approximately linear cross section over the pupil plane along the slit lengths over the amplitude mask. The same intensity distribution is therefore imposed on the light beam for each position of the mirror, and therefore the same modified light sheet is generated for each position of the mirror. Only the angle relative to the optical axis changes. The conjugate intermediate image plane in which the second scanning mirror is arranged can be arranged upstream or downstream of the amplitude mask in the direction of propagation of the light beam.

The specimens to be examined using a light-sheet microscope frequently differ in terms of their spatial extent and in principle require light sheets whose length or beam waist is adapted to the extent of the specimen. Larger specimens require longer light sheets, and shorter light sheets are advantageous for thinner specimens. It is therefore desirable to use an illumination device that offers the possibility of setting different light sheets and/or of adapting a light sheet to different specimen sizes. Usually, zoom objectives or spatial light modulators are used for this purpose in the prior art, this being associated with high technical outlay and high costs. In the illumination device according to the invention, different light sheets can be selected in various ways in a compact and cost-effective manner. A first option consists in configuring the first slit mask so that the slit widths and/or the spacing and/or the number of slits are variably adjustable. Alternatively, or additionally, the illumination device may also comprise at least one additional slit mask, which is interchangeable with the first slit mask. For example, in the simplest case, the illumination device may have an insert with a mount for a slit mask. The insert can be removed manually and the slit mask therein can be replaced. This makes it possible for the illumination device to have a very compact design. However, the slit mask has to be swapped manually. Another option consists in arranging the first slit mask and the at least one additional slit mask on a slit-mask changer. The slit-mask changer can be configured, for example, as a linear displacement unit or mask wheel, similarly to filter changers, which are configured in the form of a filter wheel. The slit mask, which is in each case optimally adapted to a specimen, can then be introduced into the beam path by displacing the linear displacement unit or rotating the mask wheel. This can be effected manually or by means of a control unit. Overall, this enables beam adaptations to be made without having to resort to more complex and expensive components such as a zoom objective or a spatial light modulator.

If the illumination device comprises a second beam-shaping optics unit according to the second alternative of the light-shaping means and an amplitude mask in the form of a first annular mask, an analogous procedure can be implemented in order to enable adaptation to different situations. For example, in the case of the first annular mask, a ring width of the at least one annular opening may be variably adjustable; alternatively or additionally, the number of annular openings on the first annular mask may also be variably adjustable. It is also possible for the illumination device to then comprise at least one additional annular mask, which is interchangeable with the first annular mask. This may be effected analogously to the manner described above for the slit mask, by means of an insert or by virtue of the first annular mask and the at least one additional annular mask being arranged on an annular-mask changer. The annular-mask changer may also be configured as a linear displacement unit or as a mask wheel.

For installation in a light-sheet microscope, an illumination device of the first alternative with a first beam-shaping optics unit and an illumination device of the second alternative with a second beam-shaping optics unit can each be configured as mutually interchangeable modules, wherein a first module comprises a first beam-shaping optics unit of the first alternative of the light-shaping means and a second module comprises a second beam-shaping optics unit according to the second alternative of the light-shaping means. When changing between static generation of the light sheet and quasi-static generation of the light sheet, the modules would then be interchanged. Each of the modules contains at least the respective beam-shaping optics unit, but optionally also an amplitude mask, in particular if the latter is not designed to be interchangeable. However, if the illumination device comprises a plurality of interchangeable amplitude masks on a slit-mask changer and/or an annular-mask changer, these can likewise be configured as constituent parts of the respective module. However, it is also conceivable for the first and the at least one additional slit mask as well as the first annular mask and the at least one additional annular mask to be integrated into a common mask changer, i.e. for both the slit-mask changer and the annular-mask changer to be configured as a common mask changer, for example as a common linear displacement unit or common mask wheel.

While it is advantageous for a compact design for the first beam-shaping optics unit and the second beam-shaping optics unit of the illumination device to be configured as mutually interchangeable modules, it is also conceivable for the illumination device to be designed such that it comprises both the first beam-shaping optics unit and the second beam-shaping optics unit and additionally has switching means for selecting one of the two beam-shaping optics units. These switching means may for example comprise pivotable mirrors, which can be used to switch the beam path between the first beam-shaping optics unit and the second beam-shaping optics unit including the amplitude masks. If both ring and slit masks are arranged on a common mask changer such as a mask wheel, a switch takes place, in terms of the amplitude mask, in such a manner that the corresponding slit or annular mask is pivoted into the beam path.

It is understood that the features mentioned above and the features still to be explained below can be used not only in the specified combinations but also in other combinations or on their own without departing from the scope of the present invention.

### BRIEF DESCRIPTION OF THE DRAWINGS

The invention will be explained in even more detail below on the basis of exemplary embodiments, with reference being made to the appended drawings, which likewise disclose features essential to the invention. These exemplary embodiments are only illustrative and should not be construed as restrictive. For example, a description of an exemplary embodiment having a multiplicity of elements or components should not be construed as meaning that all these elements or components are necessary for implementation. Rather, other exemplary embodiments may also contain alternative elements and components, fewer elements or components, or additional elements or components. Elements or components of different exemplary embodiments can be combined with one another, unless indicated otherwise. Modifications and variations that are described for one of the exemplary embodiments can also be applicable to other exemplary embodiments. In order to avoid repetition, elements that are the same or correspond to one another in different figures are denoted by the same reference signs and are not explained repeatedly. In the drawings:

FIGS. 1A-1C show an illumination device comprising a beam-shaping optics unit for shaping a static light sheet,

FIGS. 2A-2B show the illumination device additionally comprising a scanning mirror for illuminating a specimen from different angles,

FIGS. 3A-3B show a light-sheet microscope comprising the illumination device,

FIG. 4 shows a mask changer configured as a mask wheel,

FIGS. 5A-5B show the effect of a beam-shaping optics unit for shaping a quasi-static light sheet with corresponding masks, and

FIGS. 6A-6B show an illumination device comprising a beam-shaping optics unit for shaping a quasi-static light sheet.

### DETAILED DESCRIPTION OF THE DRAWINGS

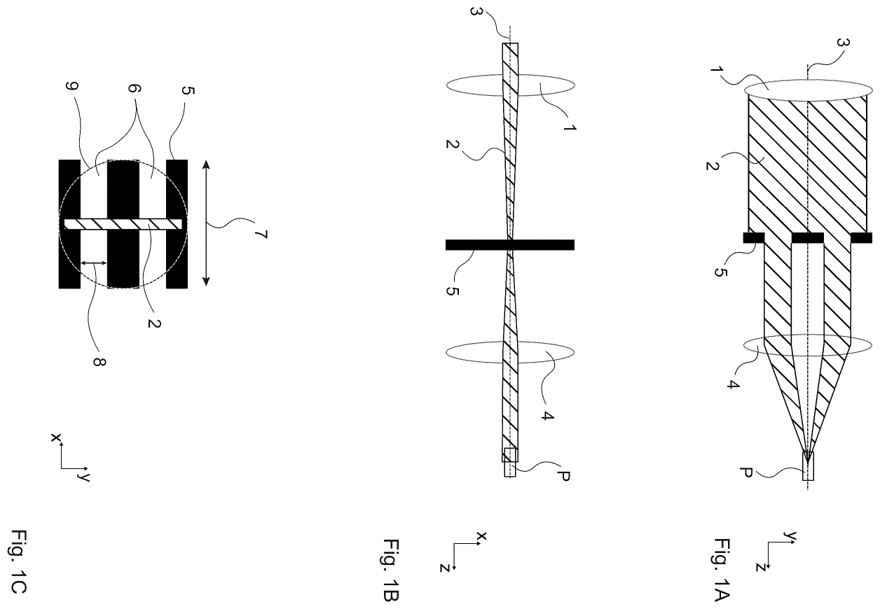

FIG. 1A and FIG. 1B show a detail of an illumination device for a light-sheet microscope, in which a static light sheet for illuminating a specimen P is generated, wherein the views of the two figures are rotated by 90° with respect to one another about an axis lying horizontally in the sheet plane—the z-axis in the coordinate system shown. The figures first of all show light-shaping means, such as a light shaper, light-shaping device or unit which shapes light which is emitted by a light source (not shown) emitting coherent light, into a light beam with a direction of propagation—from left to right in FIG. 1A and FIG. 1B; in the coordinate system shown, the direction of propagation corresponds to the z-direction. The light source may be one or more lasers, which are input coupled individually or jointly into the illumination device. In a first alternative shown here, the light-shaping means comprise a first beam-shaping optics unit. The last member of the first beam-shaping optics unit is shown here, a terminating lens 1. The first beam-shaping optics unit comprises, for example, a rotationally symmetrical concave lens (not shown here), which a collimated beam from the light source enters and exits as a divergent beam. The light subsequently enters a cylindrical lens. A cylindrical lens is characterized in that it refracts light only in one of two directions. It has an active direction, along which the light is focused (or scattered), and a passive direction, along which the light remains unaffected. The active and passive directions are orthogonal to one another. Here, in the active direction of the cylindrical lens, the light is refracted and parallelized. By contrast, in the passive direction of the cylindrical lens, the beam is further fanned out. This makes it possible to generate—as a precursor of a light sheet—a light beam 2 with a linear or rectangular cross section. An illumination optics unit, which images the light beam 2 in the form of a light sheet into a specimen P and illuminates the latter, is arranged downstream of the light-shaping means in the direction of propagation of the light beam 2. Together, the concave lens and the cylindrical lens of the first beam-shaping optics unit form, in this example, a Galilean telescope, but only in relation to the active direction of the cylindrical lens and the direction of propagation. Other configurations of the first beam-shaping optics unit than those described here are also conceivable. For example, the illumination optics unit may be configured as a microscope objective, but comprises at least one converging lens 4, which is rotationally symmetrical about an optical axis 3, on a light entrance side, on which the light beam 2 enters the illumination optics unit. An amplitude mask, which imposes an intensity distribution on the light beam and is in the form of a first slit mask 5 here, is arranged between the light-shaping means and the illumination optics unit. Here, the amplitude mask is arranged in the pupil plane of the converging lens 4, i.e. the back focal plane thereof, but may also be arranged in other conjugate pupil planes of the illumination optics unit. The first slit mask 5 is shown in detail in FIG. 1C. It comprises two slits 6 that are arranged parallel to one another and mirror symmetrically in relation to the optical axis and have slit lengths 7 and slit widths 8 that are shorter than the slit lengths. The slit lengths 7 are oriented perpendicular to a line formed by the linear cross section of the light beam 2. The first slit mask 5 is shown here from the direction from which the light is incident on the mask, so that the entire linear cross section of the light beam 2 can be seen. The extent of the pupil of the converging lens 4, the pupil diameter 9, is also shown. The z-direction thus points into the sheet plane. The slits 6 extend along the slit lengths 7, i.e. along the x-axis, preferably over the entire pupil, in order to allow as much light as possible to pass through. In the y-direction, the slit widths 8 are usually more than 20% of the pupil diameter 9. The line shape of the cross section of the light beam 2 with a corresponding line width corresponds to a cross section of a cylinder, and is thus rectangular. The extent along the y-axis is selected on the basis of the intensity distribution that has been previously imposed on the light beam 2 using the first beam-shaping optics unit. If the intensity profile has the shape of a Gaussian function, the pupil diameter 9 should be slightly overfilled, for instance by 10% or more. However, if it is a top-hat intensity profile, it is not necessary for the pupil to be overfilled. The width of the slits 6 and their spacing in the y-direction are determined on the basis of the intensity profile of the laser beam, the desired thickness of the light sheet in the specimen and the focal length of the terminating lens 4, thus making it possible to extend the light sheet by approximately 30%. If the laser beam has, for example, a Gaussian intensity profile and if the thickness w of the light sheet in the specimen at the narrowest point should correspond to the value at which the intensity of the laser beam has fallen to 1/e², with e being Euler's number, then, for a slit mask 5 with two slits 6, the slit width 8—denoted by B in the following formula—and the spacing A—with respect to the optical axis—from the inner edge of a slit 6 to the optical axis can be calculated according to the following formulae:

$$B = 1.05 \cdot f \cdot \frac{λ}{π \cdot w} and$$

$$A = 0.15 \cdot B .$$

Here, f is the focal length of the converging lens 4 and λ is the wavelength of the incident laser light.

An intensity distribution is imposed on the light beam 2 as it passes through the first slit mask 5. Since portions of the light—in FIG. 1C those portions of the light beam that are incident on the black surfaces—are blocked, this results in light losses generally of 20% to 70%, depending on the mask structure. The illumination optics unit, which is symbolized by the converging lens 4, is used to shape a light sheet that has a light-sheet thickness in the y-direction, a light-sheet length in the z-direction and a light-sheet width in the x-direction. The width of the light sheet is usually a few 100 μm to a few millimeters, depending on the region that can be captured using a detection objective of a light-sheet microscope. The light-sheet thickness can be between a few 100 nm and up to 20 μm. Finally, the light-sheet length is between 15 μm and a few millimeters.

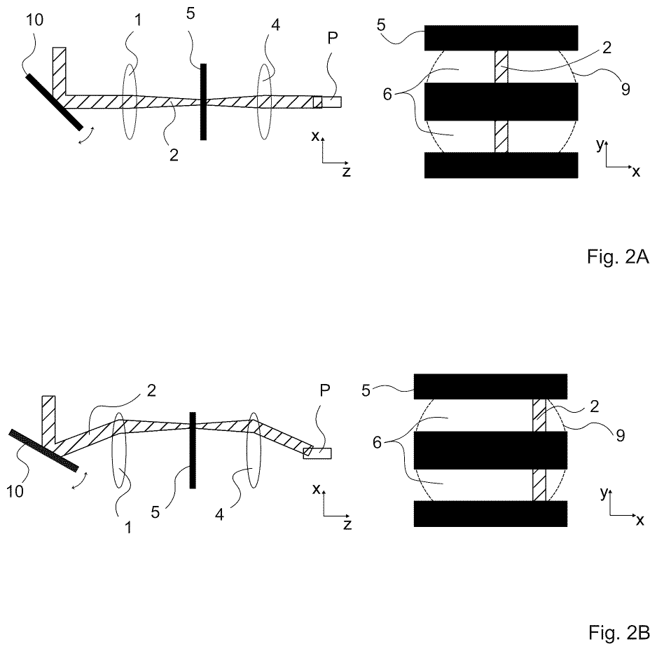

A configuration of the illumination device with a first beam-shaping optics unit according to the first alternative, which can be used to avoid a shadow of the specimen P being cast onto a camera that forms part of the detection optics unit, is shown in FIG. 2A and FIG. 2B; analogously to FIG. 1A and FIG. 1B, the two views are rotated by 90° with respect to one another. However, the first slit mask 5 is shown here from the specimen side, with the z-direction thus pointing out of the sheet plane. A second scanning mirror 10, with which a pivot scan of the light sheet can be carried out, is arranged in an intermediate image plane conjugate to an object plane of the illumination optics unit. By pivoting the mirror about the y-axis, the light beam 2, which at this point has an elliptical cross section and not yet a linear cross section, is scanned in the x-direction over the pupil and thus over the first slit mask 5. FIG. 2A and FIG. 2B show the path of the light beam 2 at different positions of the second scanning mirror 10. The same intensity distribution is imposed on the light beam 2 for each position of the second scanning mirror 10 and thus the same light sheet modified by the first slit mask 5 is generated. Solely the angle relative to the optical axis 3 changes. The scanning movement of the second scanning mirror 10 can be synchronized with the exposure time of a camera, thus making it possible to generate an almost stripe-free image of the specimen P. In this case, the terminating lens 1 transforms the intermediate image on the second scanning mirror 10 into the pupil plane with the first slit mask 5.

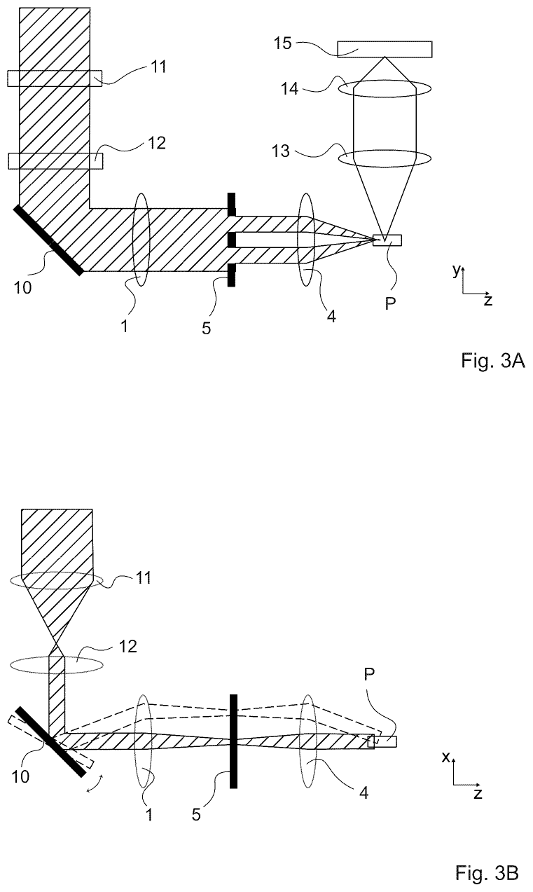

FIG. 3A and FIG. 3B show by way of example a light-sheet microscope in which the above-described illumination device with light-shaping means of the first alternative with a first beam-shaping optics unit is integrated. Analogously to FIG. 1A and FIG. 1B, the views of FIG. 3A and FIG. 3B have also been rotated, again by 90°, with respect to one another. Unlike what was described in connection with FIG. 1A, a different design for generating the precursor of the light sheet is used here, specifically a first cylindrical lens 11 and a second cylindrical lens 12. These shape the laser light into an elliptical light beam. A detection optics unit is sketched out in FIG. 3A; as is customary in light-sheet microscopes, the detection is carried out perpendicular to the light sheet plane, the xz-plane. In this schematic, the detection optics unit comprises a detection objective 13, a tube lens 14 and a camera 15.

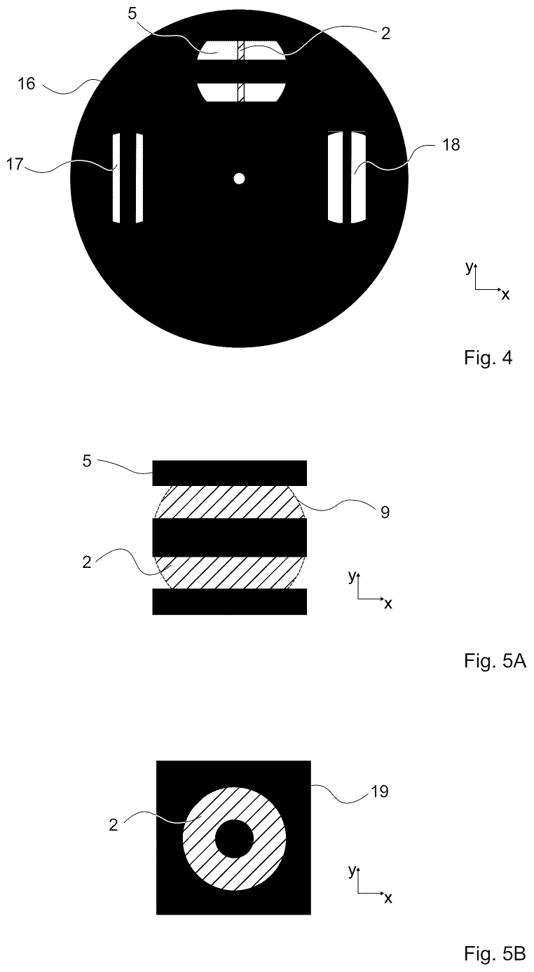

In order to be able to adapt the dimensions of the light sheet, in particular its length, but also its thickness, to different specimens, the first slit mask 5 may comprise, for example, means for adjusting the slit width and/or the spacing between the two slits 6. The number of slits can optionally also be variably adjustable. However, a mask changer provides a simple option for changing between different slit masks. A slit-mask changer configured as a mask wheel 16 is shown in FIG. 4. Firstly, the first slit mask 5, which is located in the beam path, is arranged on said mask wheel. Moreover, two additional slit masks 17, 18 are arranged on the mask wheel 16 and can be replace the first slit mask 5 by rotating the mask wheel 16.

For some specimen examinations, it is advantageous to use a quasi-static light sheet instead of a static light sheet that continuously illuminates the specimen, whereby the load applied to the specimen can be reduced, inter alia. To this end, the illumination device comprises, in a second alternative, which can be used as an alternative to the first beam-shaping optics unit, a second beam-shaping optics unit, which forms a light beam with a round cross section perpendicular to the direction of propagation. In this case too, the first slit mask 5 can be used for the sake of simplicity; this is shown in FIG. 5A. The first slit mask 5 is slightly overfilled—by greater than or equal to 10%—with a round light beam with a Gaussian intensity profile. If the light beam has an intensity profile with a top-hat distribution, there is no need for overfilling; as shown here, only the pupil is fully illuminated here. A light beam, which is modified in the y-direction, i.e. is for example sinusoidally modulated, but still has a virtually Gaussian intensity profile and is focused in the x-direction, is then generated in the specimen. If the aim is to generate a rotationally symmetrical modified beam, the amplitude mask is formed as a first annular mask 19 with at least one annular opening, as shown in FIG. 5B. The illumination device then also comprises a first scanning mirror 20, which is arranged in a pupil plane conjugate to the back focal plane of the illumination optics unit, so that the rotationally symmetrical light beam can be shaped into a quasi-static light sheet.

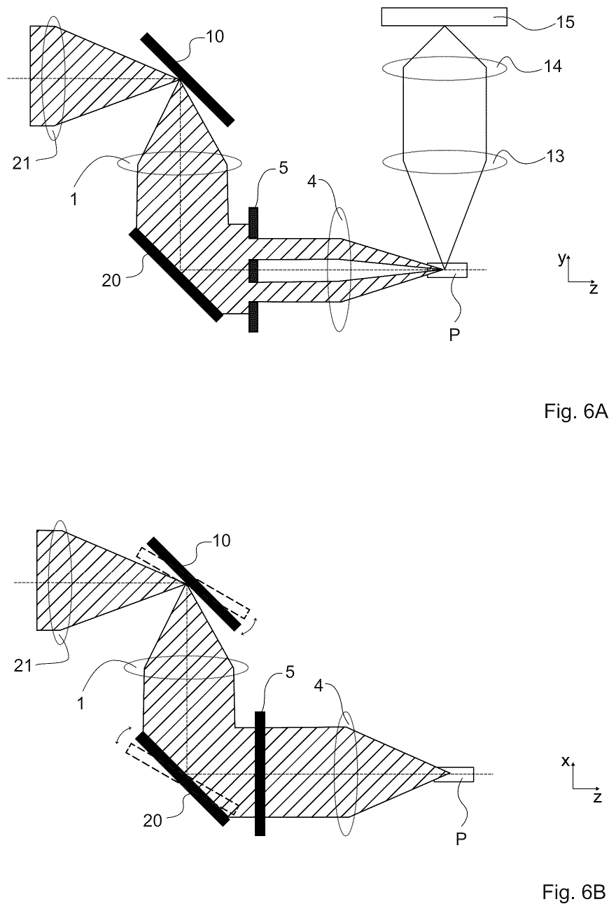

An embodiment of a light-sheet microscope with light-shaping means of a second alternative with a second beam-shaping optics unit for generating a light beam 2 with a round cross section perpendicular to the direction of propagation, the z-direction, is shown in FIG. 6A and FIG. 6B, analogously to FIGS. 3A, 3B, in the two mutually orthogonal yz- and xz-planes. A first scanning mirror 20, which, by pivoting, symbolized in FIG. 6B by the arrow upstream of the specimen in the xz-plane, is used to generate a quasi-static light sheet in the specimen once the beam has passed through the illumination optics unit 4, is located between the terminating lens 1 and the first slit mask 5 in a pupil plane conjugate to the back focal plane of the illumination optics unit—represented by the converging lens 4. Optionally, and as shown here, this second beam-shaping optics unit may also comprise a second scanning mirror 10, which is arranged in an intermediate image plane conjugate to the object plane of the illumination optics unit, in order to enable angular scanning in the yz-plane. Here, the second scanning mirror 10 is arranged between a lens 21 and the terminating lens 1.

The above-described illumination device makes it possible to generate a static or quasi-static light sheet in a compact and cost-effective manner. In the case of a static light sheet, shadowing can be eliminated. Furthermore, the thickness of the light sheet and the length of the light sheet can be easily adapted to different specimen sizes.

### LIST OF REFERENCE SIGNS

1 Terminating lens
2 Light beam
3 Optical axis
4 Converging lens
5 First slit mask
6 Slit
7 Slit length
8 Slit width
9 Pupil diameter
10 Second scanning mirror
11 First cylindrical lens
12 Second cylindrical lens
13 Detection objective
14 Tube lens
15 Camera
16 Mask wheel
17, 18 Additional slit mask
19 First annular mask
20 First scanning mirror
21 Lens
P Specimen

1. An illumination device for a light-sheet microscope, comprising
a light source emitting coherent light,
a light-shaping device, which shapes the light emitted by the light source into a light beam with a direction of propagation, wherein the light-shaping:
comprises, in a first alternative, a first beam-shaping optics unit, which forms a light beam with a linear cross section perpendicular to the direction of propagation, and
comprises, in a second alternative, a second beam-shaping optics unit, which forms a light beam with a round cross section perpendicular to the direction of propagation,
an illumination optics unit, which is arranged downstream of the light-shaping device in the direction of propagation of the light beam and has a light-entrance side, which faces the light-shaping device and at which the light beam enters the illumination optics unit, and a light-exit side, from which the light beam for illuminating a specimen exits, and which illumination optics unit comprises at least one converging lens, which is rotationally symmetrical about an optical axis and is arranged on the light-entrance side of the illumination optics unit,
an amplitude mask, which is arranged in a back focal plane or a pupil plane of the converging lens conjugate to said back focal plane and imposes an intensity distribution on the light beam, wherein the amplitude mask,
in the first alternative of the light-shaping device, is in the form of a first slit mask, which comprises at least two slits that are arranged parallel to one another and mirror symmetrically in relation to the optical axis and have slit lengths and slit widths that are shorter than the slit lengths, wherein the slit lengths are oriented perpendicular to a line formed by the linear cross section, and
in the second alternative of the light-shaping device, is either in the form of the first slit mask or in the form of a first annular mask with at least one annular opening, wherein a first scanning mirror, which is used to shape the light beam into a quasi-static light sheet, is arranged in a pupil plane conjugate to the back focal plane of the illumination optics unit.

2. The illumination device as claimed in claim 1, wherein a second scanning mirror, which can be used to displace the position of the light beam on the first slit mask along the slit lengths, is arranged in an intermediate image plane conjugate to an object plane of the illumination optics unit.

3. The illumination device as claimed in claim 1, wherein the slit widths and/or the spacing between the slits and/or the number of slits on the first slit mask are variably adjustable.

4. The illumination device as claimed in claim 1, wherein the illumination device comprises at least one additional slit mask, which is interchangeable with the first slit mask.

5. The illumination device as claimed in claim 4, wherein the first slit mask and the at least one additional slit mask are arranged on a slit-mask changer.

6. The illumination device as claimed in claim 5, wherein the slit-mask changer and/or the annular-mask changer are in the form of a mask wheel or linear displacement unit.

7. The illumination device as claimed in claim 1, comprising the second beam-shaping optics unit according to the second alternative of the light-shaping device and an amplitude mask in the form of a first annular mask, wherein the at least one annular opening of the first annular mask has a variably adjustable ring width and/or the number of annular openings on the first annular mask are variably adjustable.

8. The illumination device as claimed in claim 1, comprising the second beam-shaping optics unit according to the second alternative of the light-shaping device and an amplitude mask in the form of a first annular mask, wherein the illumination device comprises at least one additional annular mask, which is interchangeable with the first annular mask.

9. The illumination device as claimed in claim 8, wherein the first annular mask and the at least one additional annular mask are arranged on an annular-mask changer.

10. The illumination device as claimed in claim 9, wherein the slit-mask changer and/or the annular-mask changer are in the form of a mask wheel or linear displacement unit.

11. The illumination device as claimed in claim 1, wherein the illumination device comprises the first beam-shaping optics unit according to the first alternative of the light-shaping device, the second beam-shaping optics unit according to the second alternative of the light-shaping device and a switch for selecting one of the two beam-shaping optics units.

12. A light-sheet microscope comprising an illumination device as claimed in claim 1.

13. The light-sheet microscope comprising an illumination device as claimed claim 1, wherein the first beam-shaping optics unit and the second beam-shaping optics unit are configured as mutually interchangeable modules.
